(19) United States
(12) Patent Application Publication
(10) Pub. No.: US 2025/0347324 A1
(43) Pub. Date: Nov. 13, 2025

(54) DISCONNECTOR APPARATUS

(71) Applicant: Hyundai Transys Inc., Seosan-si (KR)

(72) Inventors: SE DONG YANG, Hwaseong-si (KR); Sangheon LEE, Hwaseong-si (KR); BONG JOO SHIN, Hwaseong-si (KR); JONG BAE AHN, Hwaseong-si (KR); YEON HO KIM, Hwaseong-si (KR)

(21) Appl. No.: 18/928,948

(22) Filed: Oct. 28, 2024

(30) Foreign Application Priority Data
May 8, 2024 (KR) 10-2024-0060702

(51) Int. Cl. F16D 11/14

(52) U.S. Cl. CPC F16D 11/14

(57) ABSTRACT

A disconnector apparatus includes a casing including a casing main body and a cover coupled to the casing main body, a support ring provided in the casing main body, and a clutch ring having a first clutch part provided on an outer-diameter portion thereof, and a second clutch part provided on an inner-diameter portion thereof, the clutch ring being capable of being moved toward the support ring by being pushed by a sleeve, in which the first clutch part engages with a third clutch part provided on an inner-diameter portion of the casing main body at ordinary times, and the second clutch part engages with a fourth clutch part provided on an outer-diameter portion of one side of the support ring.

### CROSS-REFERENCE TO RELATED APPLICATIONS

This application claims priority to and the benefit of Korean Patent Application No. 10-2024-0060702 filed in the Korean Intellectual Property Office on May 8, 2024, the entire contents of which are incorporated herein by reference.

### TECHNICAL FIELD

The present invention relates to a disconnector apparatus capable of switching power to four-wheel drive or two-wheel drive.

### BACKGROUND ART

In general, a disconnector apparatus may minimize an unnecessary loss of power by switching power between two-wheel drive (2WD) and four-wheel drive (4WD) by engaging or disengaging a differential shaft depending on a traveling situation.

The disconnector apparatus may include a casing main body, a cover coupled to the casing main body, a support ring mounted in the casing main body, a differential gear set including a pinion gear mounted in the support ring and left and right side gears configured to engage with the pinion gear, and a clutch ring disposed in the casing main body and configured to engage with the support ring.

A sleeve connected to an actuator device may be moved in an engagement direction by an operation of the actuator device. When the sleeve moves in the engagement direction, the clutch ring connected to the sleeve moves toward the support ring, such that an engaging (interlocking) state may be implemented in which teeth of the clutch ring engage with teeth of the support ring. Therefore, four-wheel drive (4WD) may be implemented.

On the contrary, the sleeve may be moved in a disengagement direction by the operation of the actuator device. When the sleeve moves in the disengagement direction, the clutch ring connected to the sleeve is separated from the support ring, such that the engaging state between the clutch ring and the support ring may be released. Therefore, two-wheel drive (2WD) may be implemented.

Because the disconnector apparatus in the related art has a complicated operational structure, an overall length of the vehicle excessively increases, a large space is required, and a weight increases, which degrades mountability. Further, a high differential occurs, in which the pinion gear is rotated at high speed by the rotation of the left side gear when the vehicle travels straight at high speed in the state in which the disconnector shaft and the disconnector hub are disconnected. For this reason, noise and vibration occur.

Furthermore, in the related art, because tips of the teeth of the clutch ring and the support ring of the disconnector apparatus each have a flat surface structure, there is a problem in that an impact occurs as the teeth of the clutch ring and the teeth of the support ring collide with each other when the clutch ring and the support ring engage with each other, and a large amount of time is required for the clutch ring and the support ring to engage with each other.

### Document of Related Art

### Patent Document

(Patent Document 1) Korean Patent Application Laid-Open No. 10-2017-0123869 (published on Nov. 9, 2017)

### SUMMARY OF THE INVENTION

The present invention has been made in an effort to solve the above-mentioned problem, and an object of the present invention is to provide a disconnector apparatus, in which a clutch ring engages with a support ring in a casing main body, such that four-wheel drive may be implemented.

Another object of the present invention is to provide a disconnector apparatus, in which at least one inclined contact surface and at least one counterpart inclined contact surface are formed at tips of teeth of the clutch ring and the support ring, such that the clutch ring and the support ring may smoothly engage with each other.

In order to achieve the above-mentioned objects, the present invention provides a disconnector apparatus including: a casing including a casing main body and a cover coupled to the casing main body; a support ring provided in the casing main body; and a clutch ring having a first clutch part provided on an outer-diameter portion thereof, and a second clutch part provided on an inner-diameter portion thereof, the clutch ring being capable of being moved toward the support ring by being pushed by a sleeve, in which the first clutch part engages with a third clutch part provided on an inner-diameter portion of the casing main body at ordinary times, and the second clutch part engages with a fourth clutch part provided on an outer-diameter portion of one side of the support ring.

In addition, the clutch ring may be connected to the sleeve, the second clutch part may engage with the fourth clutch part as the clutch ring is pushed toward the support ring by the sleeve, and the second clutch part and the fourth clutch part may be disengaged as the clutch ring is pushed away from the support ring by a disengagement operation of the sleeve.

In addition, at least one inclined contact surface may be provided at a tip of a tooth of the second clutch part, at least one counterpart inclined contact surface may be provided at a tip of a tooth of the fourth clutch part, and the second clutch part and the fourth clutch part may engage with each other as the inclined contact surface slides in a state in which the inclined contact surface is in contact with the counterpart inclined contact surface.

In addition, the inclined contact surface may be provided at one side of the tip of the tooth of the second clutch part, and the inclined contact surface may define an acute angle with respect to a tip end of the tooth of the second clutch part.

In addition, the counterpart inclined contact surface may be provided at one side of the tip of the tooth of the fourth clutch part opposite to the inclined contact surface, and the counterpart inclined contact surface may define an acute angle with respect to a tip end of the tooth of the fourth clutch part.

In addition, the inclined contact surface may be provided at one side of the tip of the tooth of the second clutch part, a tip end of the tooth of the second clutch part, which excludes the inclined contact surface, may be configured as a flat surface, and the inclined contact surface may define an obtuse angle with respect to the tip end of the tooth of the second clutch part.

In addition, the counterpart inclined contact surface may be provided at one side of the tip of the tooth of the fourth clutch part opposite to the inclined contact surface, a tip end of the tooth of the fourth clutch part, which excludes the counterpart inclined contact surface, may be configured as a flat surface, and the counterpart inclined contact surface may define an obtuse angle with respect to the tip end of the tooth of the fourth clutch part.

In addition, the inclined contact surfaces may be provided at two opposite sides of the tip of the tooth of the second clutch part.

In addition, the counterpart inclined contact surfaces may be provided at two opposite sides of the tip of the tooth of the fourth clutch part opposite to the inclined contact surfaces provided at the two opposite sides.

In addition, a tip end of the tooth of the second clutch part, which is positioned between the inclined contact surfaces provided at the two opposite sides, may be configured as a flat surface, and the inclined contact surface may define an obtuse angle with respect to the tip end of the tooth of the fourth clutch part.

In addition, a tip end of the tooth of the fourth clutch part, which is provided between the counterpart inclined contact surfaces provided at the two opposite sides, may be configured as a flat surface, and the counterpart inclined contact surface may define an obtuse angle with respect to the tip end of the tooth of the fourth clutch part.

In addition, a catching projection may be provided on an outer-diameter portion of the casing main body to which the sleeve is coupled, a catching surface may be provided on one surface of the sleeve directed toward the catching projection, and the catching surface of the sleeve, which is moved along the outer-diameter portion of the casing main body by an operation of an actuator device, may be caught by the catching projection such that a movement of the sleeve is restricted.

In addition, at least one pressing portion may be provided on a surface of the sleeve directed toward the clutch ring, the pressing portion may pass through a through-hole provided in the casing main body, and the pressing portion may be connected to the clutch ring provided in the casing main body.

In addition, the pressing portion may push the clutch ring toward the support ring to allow the second clutch part to engage with the fourth clutch part, or the pressing portion may pull the clutch ring away from the support ring to disengage the second clutch part and the fourth clutch part.

In addition, during an operation of disengaging the second clutch part and the fourth clutch part, the pressing portion may be caught by a catching member mounted in the casing main body such that a movement of the pressing portion is restricted.

According to the present invention, the clutch ring is pushed toward the support ring by the operation of the sleeve in the state in which the first clutch part engages with the third clutch part of the casing main body at ordinary times, such that the second clutch part may engage with the fourth clutch part of the support ring, such that the four-wheel drive may be implemented.

In addition, according to the present invention, when the auxiliary driving wheels coast in the two-wheel drive mode in accordance with the disengagement between the second clutch part and the fourth clutch part, the support ring, which supports the differential gear set including the two side gears and the four pinion gears, rotates, which makes it possible to solve the problem of noise caused by a high differential in the related art.

In addition, the present invention may significantly reduce the overall length, thereby reducing the weight and greatly improving the packaging mountability.

In addition, according to the present invention, at least one inclined contact surface and at least one counterpart inclined contact surface are formed at the tips of the teeth of the second clutch part of the clutch ring and the fourth clutch part of the support ring, such that the second clutch part and the fourth clutch part may smoothly engage with each other.

In addition, according to the present invention, it is possible to solve the problem in the related art in that because the tips of the teeth of the clutch ring and the support ring each have a flat surface structure, an impact occurs as the teeth of the clutch ring and the teeth of the support ring collide with each other when the clutch ring and the support ring engage with each other, and a large amount of time is required for the clutch ring and the support ring to engage with each other.

The foregoing summary is illustrative only and is not intended to be in any way limiting. In addition to the illustrative aspects, embodiments, and features described above, further aspects, embodiments, and features will become apparent by reference to the drawings and the following

### BRIEF DESCRIPTION OF THE DRAWINGS

FIG. 1 is a perspective view of a disconnector apparatus according to an exemplary embodiment of the present invention.

FIG. 2 is a view illustrating a state in which a differential gear set is assembled in a support ring according to the exemplary embodiment of the present invention.

FIG. 3 is an exploded perspective view of the disconnector apparatus according to the exemplary embodiment of the present invention.

FIG. 4 is a cross-sectional side view of the disconnector apparatus according to the exemplary embodiment of the present invention.

FIG. 5 is a view schematically illustrating teeth of a clutch ring and the support ring according to a first embodiment.

FIG. 6 is a view schematically illustrating teeth of the clutch ring and the support ring according to a second embodiment.

FIG. 7 is a view schematically illustrating teeth of the clutch ring and the support ring according to a third embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention. Further, the exemplary embodiments of the present invention will be described below, but the technical spirit of the present invention is not limited thereto and may of course be modified and variously carried out by those skilled in the art.

The present invention may be applied to electric vehicles (EV, battery electric vehicle), internal combustion engine (ICE) vehicles, hybrid electric vehicles (HEV), and the like.

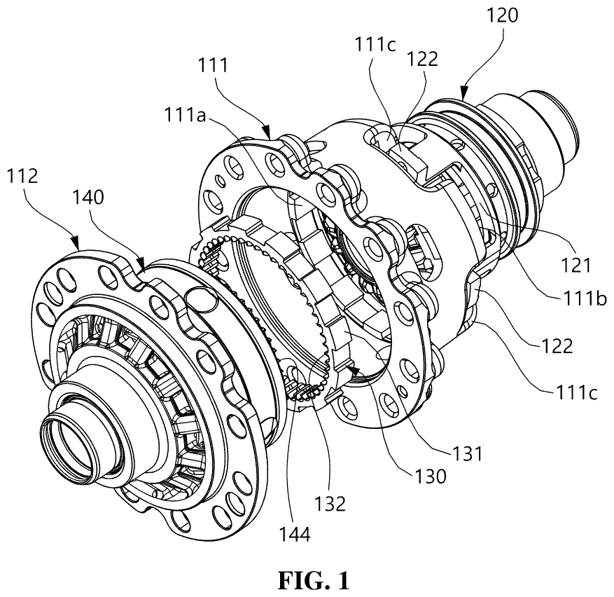

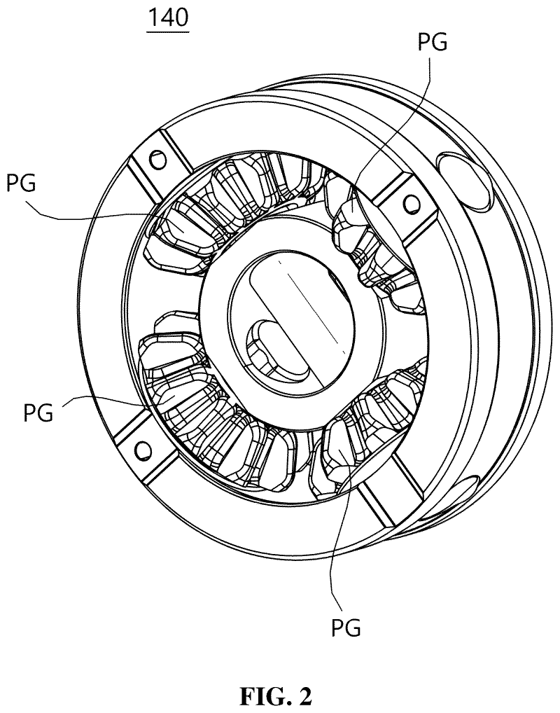

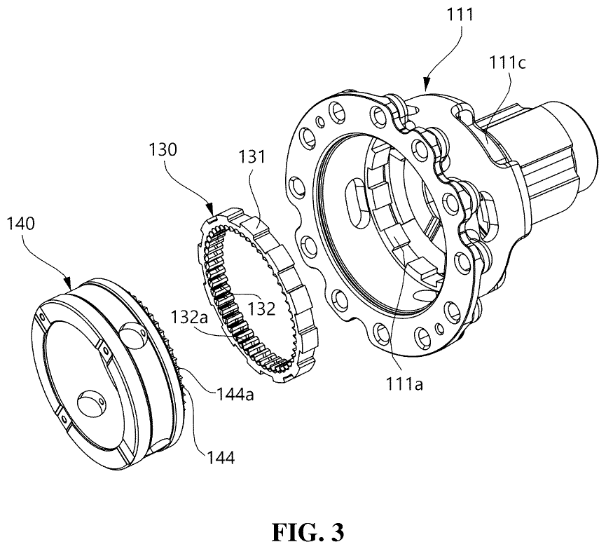

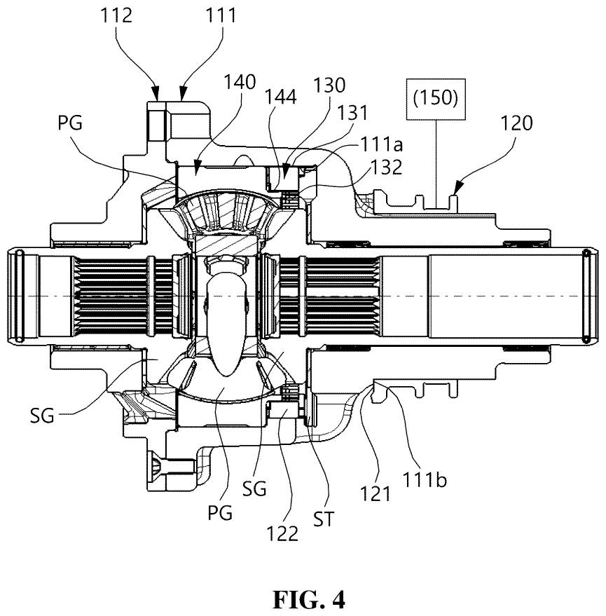

FIG. 1 is a perspective view of a disconnector apparatus according to an exemplary embodiment of the present invention, FIG. 2 is a view illustrating a state in which a differential gear set is assembled in a support ring according to the exemplary embodiment of the present invention, FIG. 3 is an exploded perspective view of the disconnector apparatus according to the exemplary embodiment of the present invention, and FIG. 4 is a cross-sectional side view of the disconnector apparatus according to the exemplary embodiment of the present invention.

As illustrated in FIGS. 1 to 4, a disconnector apparatus of the present invention may include a casing including a casing main body 111 and a cover 112 coupled to the casing main body 111, a support ring 140 provided in the casing main body 111, a differential gear set including a side gear SG mounted in the support ring 140, and a pinion gear PG configured to engage with the side gear SG, a clutch ring 130 disposed in the casing main body 111 and configured to engage with the support ring 140, and a sleeve 120 connected to the clutch ring 130.

When an actuator device 150 operates, the sleeve 120 connected to the actuator device 150 may push the clutch ring 130 toward the support ring 140, such that the clutch ring 130 and the support ring 140 may engage with each other.

The casing main body 111 may have a catching projection 111b. The catching projection 111b may be provided on an outer-diameter portion to which the sleeve 120 of the casing main body 111 is coupled.

When the actuator device 150 operates, the sleeve 120 provided on the outer-diameter portion of the casing main body 111 may move toward the support ring 140 along the outer-diameter portion of the casing main body 111.

The sleeve 120 may have a catching surface 121. The catching surface 121 may be provided on one side surface of the sleeve 120 directed toward the catching projection 111b. The catching surface 121 may be caught by the catching projection 111b, such that the movement of the sleeve 120 may be restricted.

The sleeve 120 may have a pressing portion 122. One or more pressing portions 122 may be provided on a surface of the sleeve 120 directed toward the clutch ring 130. The pressing portion 122 may pass through a through-hole 111c provided in the casing main body 111, and the pressing portion 122 may be positioned in the casing main body 111. The pressing portion 122 may be connected to the clutch ring 130 in the casing main body 111.

The pressing portion 122 and the clutch ring 130 may be connected by various publicly-known connection structures such as bolting.

The clutch ring 130 may have a first clutch part 131 provided on an outer-diameter portion thereof, and a second clutch part 132 provided on an inner-diameter portion thereof.

A third clutch part 111a may be provided on an inner-diameter portion of the casing main body 111. A fourth clutch part 144 provided on an outer-diameter portion of one side of the support ring 140.

The first clutch part 131 of the clutch ring 130 may engage with the third clutch part 111a of the casing main body 111 at ordinary times.

In a situation in which four-wheel drive traveling performance, such as acceleration, is required or in a situation in which regenerative braking is required, the second clutch part 132 of the clutch ring 130 may engage with the fourth clutch part 144 of the support ring 140.

For example, the second clutch part 132 of the clutch ring 130 may be disengaged from the fourth clutch part 144 of the support ring 140 during the two-wheel drive, and the second clutch part 132 of the clutch ring 130 may be disengaged from the fourth clutch part 144 of the support ring 140 during the four-wheel drive.

In the state in which the sleeve 120 is coupled to the outer-diameter portion of the casing main body 111, the sleeve 120 may move along the outer-diameter portion of the casing main body 111.

The sleeve 120 connected to the actuator device 150 may be moved in the engagement direction by the operation of the actuator device 150. When the sleeve 120 moves in the engagement direction, the clutch ring 130 connected to the sleeve 120 moves toward the support ring 140, such that an engaging (interlocking) state may be implemented in which teeth 132a of the second clutch part 132 of the clutch ring 130 engage with teeth 144a of the fourth clutch part 144 of the support ring 140. Therefore, four-wheel drive (4WD) may be implemented.

In this case, the catching surface 121 of the sleeve 120 is caught by the catching projection 111b of the casing main body 111, such that the sleeve 120 is stopped without moving toward the support ring 140 any further.

On the contrary, the sleeve 120 may be moved in a disengagement direction by the operation of the actuator device 150. As the sleeve 120 moves in the disengagement direction, the second clutch part 132 of the clutch ring 130 connected to the sleeve 120 and the fourth clutch part 144 of the support ring 140 may be disengaged. Therefore, two-wheel drive (2WD) may be implemented.

During the operation of disengaging the second clutch part 132 of the sleeve 120 and the fourth clutch part 144, the pressing portion 122 may be caught by a catching member ST mounted in the casing main body 111, such that the movement of the pressing portion 122 may be restricted. For example, the catching member ST may be a stop ring.

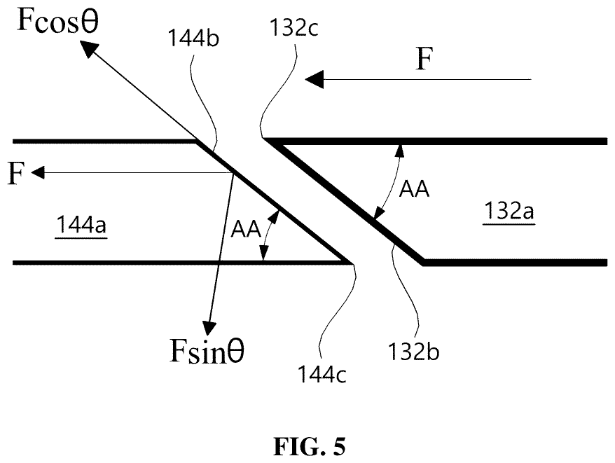

FIG. 5 is a view schematically illustrating teeth of the clutch ring and the support ring according to a first embodiment.

As illustrated in FIGS. 3 and 5, the teeth 132a of the second clutch part 132 of the clutch ring 130 may be formed along the inner-diameter portion. The teeth 144a of the fourth clutch part 144 of the support ring 140 may be formed along the outer-diameter portion of one side directed toward the second clutch part 132.

An inclined contact surface 132b may be provided at one side of the tip of the tooth 132a of the second clutch part 132.

The inclined contact surface 132b may be configured as an inclined surface that defines an acute angle AA with respect to a tip end 132c of the tooth 132a of the second clutch part 132.

A counterpart inclined contact surface 144b may be provided at one side of the tip of the tooth 144a of the fourth clutch part 144 of the support ring 140 opposite to the inclined contact surface 132b.

The counterpart inclined contact surface 144b may be configured as an inclined surface that defines the acute angle AA with respect to a tip end 144c of the tooth 144a of the fourth clutch part 144.

When the second clutch part 132 and the fourth clutch part 144 engage with each other, the clutch ring 130 moves toward the support ring 140, such that the inclined contact surface 132b of the tooth 132a of the second clutch part 132 may come into contact with the counterpart inclined contact surface 144b of the tooth 144a of the fourth clutch part 144.

In the state in which the inclined contact surface 132b is in contact with the counterpart inclined contact surface 144b of the tooth 144a of the fourth clutch part 144, the tooth 132a of the second clutch part 132 may be easily inserted between the teeth 144a of the fourth clutch part 144 while sliding along the counterpart inclined contact surface 144b.

The second clutch part 132 and the fourth clutch part 144 may smoothly engage with each other by the inclined contact surface 132b and the counterpart inclined contact surface 144b.

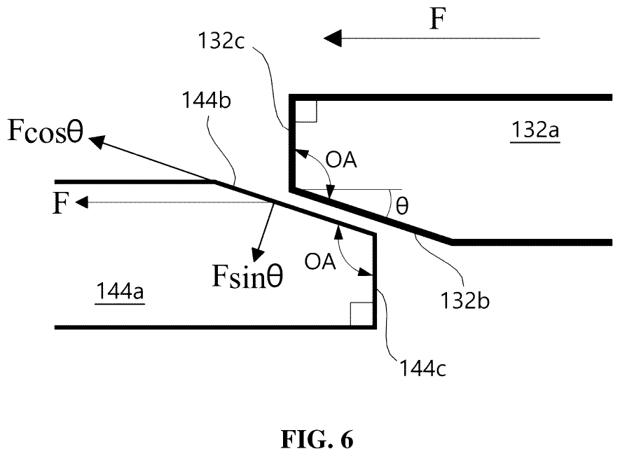

FIG. 6 is a view schematically illustrating teeth of the clutch ring and the support ring according to a second embodiment.

As illustrated in FIGS. 3 and 6, the teeth 132a of the second clutch part 132 of the clutch ring 130 may be formed along the inner-diameter portion. The teeth 144a of the fourth clutch part 144 of the support ring 140 may be formed along the outer-diameter portion of one side directed toward the clutch ring 130.

The inclined contact surface 132b may be provided at one side of the tip of the tooth 132a of the second clutch part 132.

The tip end 132c of the tooth 132a of the second clutch part 132, which excludes the inclined contact surface 132b, may be configured as a flat surface.

The tip end 132c of the tooth 132a of the second clutch part 132, which is configured as a flat surface, and a side surface of the adjacent tooth 132a of the second clutch part 132 may define a right angle.

The inclined contact surface 132b may be configured as an inclined surface that defines an obtuse angle OA with respect to the tip end 132c of the tooth 132a of the second clutch part 132.

The counterpart inclined contact surface 144b may be provided at one side of the tip of the tooth 144a of the fourth clutch part 144 opposite to the inclined contact surface 132b.

The tip end 144c of the tooth 144a of the fourth clutch part 144, which excludes the counterpart inclined contact surface 144b, may be configured as a flat surface.

The counterpart inclined contact surface 144b may be configured as an inclined surface that defines the obtuse angle OA with respect to the tip end 144c of the tooth 144a of the fourth clutch part 144.

When the second clutch part 132 and the fourth clutch part 144 engage with each other, the second clutch part 132 moves toward the fourth clutch part 144, such that the inclined contact surface 132b of the tooth 132a of the second clutch part 132 may come into contact with the counterpart inclined contact surface 144b of the fourth clutch part 144.

In the state in which the inclined contact surface 132b is in contact with the counterpart inclined contact surface 144b of the fourth clutch part 144, the tooth 132a of the second clutch part 132 may be easily inserted between the teeth 144a of the fourth clutch part 144 while sliding along the counterpart inclined contact surface 144b.

The second clutch part 132 and the fourth clutch part 144 may smoothly engage with each other by the inclined contact surface 132b and the counterpart inclined contact surface 144b.

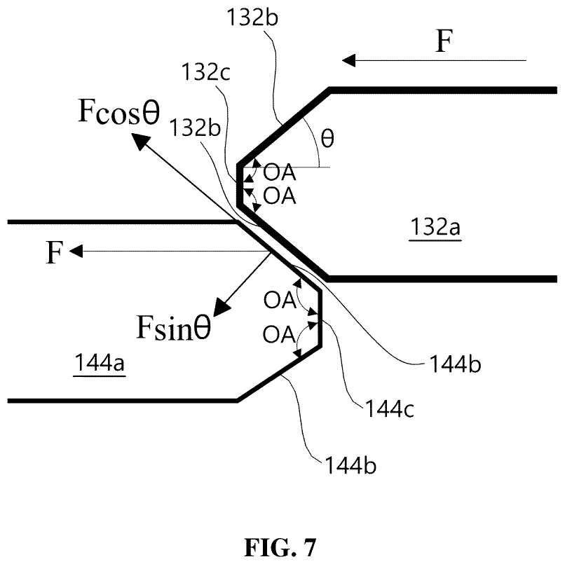

FIG. 7 is a view schematically illustrating teeth of the clutch ring and the support ring according to a third embodiment.

As illustrated in FIGS. 3 and 7, the teeth 132a of the second clutch part 132 of the clutch ring 130 may be formed along the inner-diameter portion. The teeth 144a of the fourth clutch part 144 of the support ring 140 may be formed along the outer-diameter portion of one side directed toward the second clutch part 132.

The inclined contact surfaces 132b may be provided at two opposite sides of the tip of the tooth 132a of the second clutch part 132.

The counterpart inclined contact surfaces 144b may be provided at two opposite sides of the tip of the tooth 144a of the fourth clutch part 144 opposite to the inclined contact surfaces 132b provided at the two opposite sides.

The tip end 132c of the tooth 132a of the second clutch part 132, which is positioned between the inclined contact surfaces 132b provided at two opposite sides, may be configured as a flat surface.

The inclined contact surface 132b may be configured as an inclined surface that defines the obtuse angle OA with respect to the tip end 132c of the tooth 132a of the second clutch part 132 that is configured as a flat surface.

The tip end 144c of the tooth 144a of the fourth clutch part 144, which is provided between the counterpart inclined contact surfaces 144b provided at two opposite sides, may be configured as a flat surface.

The counterpart inclined contact surface 144b may define the obtuse angle OA with respect to the tip end 144c of the tooth 144a of the fourth clutch part 144.

When the second clutch part 132 and the fourth clutch part 144 engage with each other, the clutch ring 130 moves toward the support ring 140, such that at least one of the inclined contact surfaces 132b provided at the two opposite sides of the tooth 132a of the second clutch part 132 may come into contact with the counterpart inclined contact surface 144b of the opposing fourth clutch part 144.

In the state in which the inclined contact surface 132b is in contact with the counterpart inclined contact surface 144b of the tooth 144a of the fourth clutch part 144, the tooth 132a of the second clutch part 132 may be easily inserted between the teeth 144a of the fourth clutch part 144 while sliding along the counterpart inclined contact surface 144b.

The second clutch part 132 and the fourth clutch part 144 may smoothly engage with each other by the inclined contact surface 132b and the counterpart inclined contact surface 144b.

According to the present invention described above, the clutch ring is pushed toward the support ring by the operation of the sleeve in the state in which the first clutch part engages with the third clutch part of the casing main body at ordinary times, such that the second clutch part may engage with the fourth clutch part of the support ring, such that the four-wheel drive may be implemented. In addition, according to the present invention, when the auxiliary driving wheels coast in the two-wheel drive mode in accordance with the disengagement between the second clutch part and the fourth clutch part, the support ring, which supports the differential gear set including the two side gears and the four pinion gears, rotates, which makes it possible to solve the problem of noise caused by a high differential in the related art. In addition, the present invention may significantly reduce the overall length, thereby reducing the weight and greatly improving the packaging mountability. In addition, according to the present invention, at least one inclined contact surface and at least one counterpart inclined contact surface are formed at the tips of the teeth of the second clutch part of the clutch ring and the fourth clutch part of the support ring, such that the second clutch part and the fourth clutch part may smoothly engage with each other. In addition, according to the present invention, it is possible to solve the problem in the related art in that because the tips of the teeth of the clutch ring and the support ring each have a flat surface structure, an impact occurs as the teeth of the clutch ring and the teeth of the support ring collide with each other when the clutch ring and the support ring engage with each other, and a large amount of time is required for the clutch ring and the support ring to engage with each other.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A disconnector apparatus comprising:
a casing including a casing main body and a cover coupled to the casing main body;
a support ring disposed in the casing main body; and
a clutch ring having a first clutch part disposed on an outer-diameter portion thereof, and a second clutch part disposed on an inner-diameter portion of the clutch ring, the clutch ring being capable of being moved toward the support ring by being pushed by a sleeve,
wherein the first clutch part is configured to engage with a third clutch part disposed on an inner-diameter portion of the casing main body, and the second clutch part is configured to engage with a fourth clutch part disposed on an outer-diameter portion of one side of the support ring.

2. The disconnector apparatus of claim 1,
wherein the clutch ring is connected to the sleeve,
wherein the second clutch part is configured to engage with the fourth clutch part as the clutch ring is pushed toward the support ring by the sleeve, and
wherein the second clutch part and the fourth clutch part are configured to be disengaged as the clutch ring is pushed away from the support ring by a disengagement operation of the sleeve.

3. The disconnector apparatus of claim 2,
wherein at least one inclined contact surface is defined at a tip of a tooth of the second clutch part,
wherein at least one counterpart inclined contact surface is defined at a tip of a tooth of the fourth clutch part, and
wherein the second clutch part and the fourth clutch part are configured to engage with each other as the at least one inclined contact surface slides in a state in which the at least one inclined contact surface is in contact with the at least one counterpart inclined contact surface.

4. The disconnector apparatus of claim 3,
wherein the at least one inclined contact surface is defined at one side of the tip of the tooth of the second clutch part, and
wherein the at least one inclined contact surface defines an acute angle with respect to a tip end of the tooth of the second clutch part.

5. The disconnector apparatus of claim 4,
wherein the at least one counterpart inclined contact surface is defined at one side of the tip of the tooth of the fourth clutch part opposite to the at least one inclined contact surface, and
wherein the at least one counterpart inclined contact surface defines an acute angle with respect to a tip end of the tooth of the fourth clutch part.

6. The disconnector apparatus of claim 3,
wherein the at least one inclined contact surface is defined at one side of the tip of the tooth of the second clutch part,
wherein a tip end of the tooth of the second clutch part, which excludes the at least one inclined contact surface, has a flat surface, and
wherein the at least one inclined contact surface defines an obtuse angle with respect to the tip end of the tooth of the second clutch part.

7. The disconnector apparatus of claim 6,
wherein the at least one counterpart inclined contact surface is defined at one side of the tip of the tooth of the fourth clutch part opposite to the at least one inclined contact surface,
wherein a tip end of the tooth of the fourth clutch part, which excludes the at least one counterpart inclined contact surface, has a flat surface, and
wherein the at least one counterpart inclined contact surface defines an obtuse angle with respect to the tip end of the tooth of the fourth clutch part.

8. The disconnector apparatus of claim 3,
wherein the at least one inclined contact surface is defined at two opposite sides of the tip of the tooth of the second clutch part.

9. The disconnector apparatus of claim 8,
wherein the at least one counterpart inclined contact surface is defined at two opposite sides of the tip of the tooth of the fourth clutch part opposite to the at least one inclined contact surface defined at the two opposite sides of the tip of the tooth of the second clutch part.

10. The disconnector apparatus of claim 9,
wherein a tip end of the tooth of the second clutch part, which is positioned between the at least one inclined contact surface defined at the two opposite sides of the tip of the tooth of the second clutch part, has a flat surface, and
wherein each of the at least one inclined contact surface defines an obtuse angle with respect to the tip end of the tooth of the second clutch part.

11. The disconnector apparatus of claim 10,
wherein a tip end of the tooth of the fourth clutch part, which is defined between the at least one counterpart inclined contact surface defined at the two opposite sides of the tip of the tooth of the fourth clutch part, has a flat surface, and
wherein each of the at least one counterpart inclined contact surface defines an obtuse angle with respect to the tip end of the tooth of the fourth clutch part.

12. The disconnector apparatus of claim 2,
wherein a catching projection is defined on an outer-diameter portion of the casing main body to which the sleeve is coupled,
wherein a catching surface is defined on one surface of the sleeve directed toward the catching projection, and
wherein the catching surface of the sleeve, which is configured to be moved along the outer-diameter portion of the casing main body by an operation of an actuator device, is configured to be caught by the catching projection to restrict a movement of the sleeve.

13. The disconnector apparatus of claim 2,
wherein at least one pressing portion is disposed on a surface of the sleeve directed toward the clutch ring,
wherein the at least one pressing portion passes through a through-hole defined in the casing main body, and
wherein the at least one pressing portion is connected to the clutch ring disposed in the casing main body.

14. The disconnector apparatus of claim 13,
wherein the at least one pressing portion is configured to push the clutch ring toward the support ring to allow the second clutch part to engage with the fourth clutch part, or the at least one pressing portion is configured to pull the clutch ring away from the support ring to disengage the second clutch part and the fourth clutch part.

15. The disconnector apparatus of claim 14,
wherein during an operation of disengaging the second clutch part and the fourth clutch part, the at least one pressing portion is configured to be caught by a catching member mounted in the casing main body to restrict a movement of the at least one pressing portion.
